(19) United States
(12) Patent Application Publication
(10) Pub. No.: US 2005/0208196 A1
(43) Pub. Date: Sep. 22, 2005

(54) Edible emulsion for hot food products

(76) Inventors: Vilairat Charoenwongse, Dijon (FR); Soheila Etminan-Basseri, Heilbronn (DE)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/513,442

(22) PCT Filed: Apr. 9, 2003
(86) PCT No.: PCT/EP03/03708

§ 371 Date: Nov. 3, 2004

(30) Foreign Application Priority Data
May 8, 2002 (EP) 02253198.2

(51) Int. Cl. A23D 7/00

(52) U.S. Cl. 426/602

(57) ABSTRACT

The invention provides oil-in-water food emulsions for use with hot food products. The emulsions have a pH at 20° C. in the range of from 3 to 4 and comprise 20 to 65% wt oil and a themo-reversible emulsion forming material. The emulsions have a Stevens value at 20° C. in the range of from 250 to 600 and at 50° C. in the range of from 250 to 700. The products show good stability and thickness at ambient temperature and also good melting characteristics upon contact with hot food products. A process for making the food emulsion is also provided.

### FIELD OF THE INVENTION

The present invention relates to edible emulsions (dressings or sauces) for hot food products, which emulsions show certain melting-type characteristics on contact with those food products, and to processes for preparing the emulsions.

### BACKGROUND ART

Consumers are increasingly looking for ways to vary the taste or texture of their meals, for example to provide different tastes or textures to a basic meal type. One way in which this can be achieved is through the use of different sauces or dressings so that many different favour possibilities can be provided for a given meal type. This is well known for cold meals, for example salad dressings, and also for hot meals, for example pour-over sauces for meat, fish or poultry. Such products are generally edible emulsion food products, and usually edible oil-in-water emulsion food products.

However, a problem typically encountered with such sauces or dressings intended to be applied to hot food products is that they often do not exhibit both acceptable stability and/or thickness at ambient storage temperatures and also acceptable physical properties when they come into contact with the hot food product. The sauces or dressings are often found either not to exhibit a sufficiently great viscosity change between ambient and the temperature of the hot food product so that they remain substantially unchanged in viscosity on the hot food product, or, they are not stable upon storage.

In particular, the sauce or dressing should be physically stable whilst in contact with the hot food product (that is it should not separate into more, or different, phases than in which it exists at ambient temperature). Furthermore, its appearance when in contact with the hot food product should be acceptable for the consumer. It is often desired by consumers that the dressing or sauce should exhibit a ‘melting’ appearance when in contact with the hot food product. This melting appearance is believed to be a function of the viscosity change which occurs in the food emulsion when it is contacted with the hot food product.

These different requirements of stability at ambient temperature and certain physical properties when contacted with a hot food product have been found in practice to be difficult to provide for a sauce or dressing product, especially for acidic products.

EP-A-459562 discloses cooking cream products which have a pH of about 4.4 and which comprise gelatin as a thickener.

EP-A-363741 discloses imitation cheese products which comprise enzymatically prepared pregelatinized branched starches. The cheese products have the normal pH for a cheese, that is greater than pH 4 at 20° C.

U.S. Pat. No. 3,986,890 discloses a method for the production of starch hydrolysis products which are glossy thermoreversible gels. The starches may be used in many food products such as sauces but there is no teaching of particular physical characteristics of these products.

U.S. Pat. No. 5,633,030 discloses gelling agents for the food industry, which gels set reversibly on cooking.

U.S. Pat. No. 5,508,056 discloses fat continuous (water-in-oil) emulsions which comprise gelatin as a gelling agent.

JP-11028073 discloses a solid sauce which becomes paste-like by heating during cooking. The Stevens value at 20oC of such a sauce will be greater than 600 and will be greater than 200 at 50oC. JP-10229857 also discloses solid sauces which become paste-like when heated in cooking and the same comments as for JP-11028073 apply.

JP-09149772 discloses acidic oil-in-water emulsions which comprise 40% wt or less oil, gelatin and milk protein. The milk protein helps to give resistance to both freezing and heating. All examples, including comparative examples, have either high Stevens values at 20° C. or high or low Stevens values at 50° C.

Accordingly there is a need in the art to provide a sauce or dressing type food emulsion product to be used with hot food products, which food emulsion product exhibits good stability and/or product thickness upon storage at ambient temperatures and acceptable physical characteristics upon contact with a hot food product. In particular there is a need to provide such a product to be used with hot food products, which exhibits good stability and/or product thickness on storage at ambient temperatures and an appearance of melting upon contact with a hot food product.

The present invention seeks to address one or more of the above-mentioned technical problems. In particular, it seeks to provide a sauce or dressing type food emulsion product to be used with hot food products, which food emulsion product exhibits good stability and/or product thickness upon storage at ambient temperatures and acceptable physical characteristics, especially an appearance of melting, upon contact with a hot food product.

### SUMMARY OF THE INVENTION

Surprisingly, we have found that the above-mentioned technical problems are addressed when 20 to 65% wt oil and a thermo-reversible emulsion forming material are used in certain oil-in-water food emulsions, and, the food emulsions have given Stevens values at 20° C. and 50° C.

Thus according to a first aspect of the present invention there is provided an oil-in-water food emulsion having a pH at 20oC in the range of from 3 to 4 and comprising (i) from 20 to 65% wt oil and (ii) a thermo-reversible emulsion forming material, and wherein the food emulsion has a Stevens value at 20° C. in the range of from 250 to 600 and a Stevens value at 50° C. in the range of from 100 to 200.

It is especially preferred that the Stevens value at 20° C. is in the range of from 300 to 600. It is also especially preferred that the Stevens value at 50° C. is in the range of from 120 to 160.

Gelatin has been found to be especially advantageous as the thermo-reversible emulsion forming material.

We have found that the oil-in-water food emulsions of the invention provide good storage stability at ambient temperature and also an acceptable thickness (viscosity). Furthermore, they exhibit good physical properties on contact with hot food products and exhibit a melting appearance which consumers find pleasing.

According to a second aspect of the present invention there is provided a process for the preparation of an oil-in-water food emulsion having a pH at 20oC in the range of from 3 to 4 and comprising (i) from 20 to 65% wt oil and (ii) a thermo-reversible emulsion forming material, the process comprising the steps of;
a) forming a first liquid phase comprising the thermo-reversible emulsion forming material and water, and wherein the first liquid phase is formed at a temperature in the range of from 60 to 95° C.,
b) mixing at least a part of the first liquid phase with an emulsifier to form an emulsifier-containing first liquid phase,
c) mixing at least a part of the oil with the emulsifier-containing first liquid phase,
d) mixing the, or any, remaining first liquid phase and remaining oil with the emulsifier-containing first liquid phase to form the oil-in-water food emulsion.

The process is simple to perform and provides good results.

The term ‘melting appearance’ as used herein refers to the appearance of the food emulsion when it is in contact with a hot food product and undergoes a visible change in appearance which gives the impression to the observer that the food emulsion is melting, at least to some extent. It is not required that the emulsion actually melts when in contact with the hot food product. This visible change may be observed as a thinning of the food emulsion or as the appearance of ‘smears’ therein.

A ‘hot food product’ as used herein refers to food products which are served hot, especially those which are at a temperature of 50° C. or above when contacted with the food emulsion of the invention.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

Except in the operating and comparative examples, or where otherwise explicitly indicated, all numbers in this description indicating amounts of material or conditions of reaction, physical properties of materials and/or use are to be understood as modified by the word “about.” All amounts are by weight, unless otherwise specified.

### DETAILED DESCRIPTION OF THE INVENTION

The food emulsions of the invention are oil-in-water food emulsions which have a Stevens value at 20° C. in the range of from 250 to 600.

Stevens values give an indication of the firmness (spoonability or spreadability) of a product. The Stevens value as referred to herein is measured on the product which is either at 20° C. or 50° C. using a Stevens LFRA Texture Analyser using the following parameters; 25 mm depth, speed of penetration 2.0 mm per second, using a normal programme, grid mesh of 3.8 cm by 3.8 cm with apertures of 8 mm by 8 mm. The values are quoted herein as the Stevens value (in g). The accuracy of this measurement in all cases is up to ± about 10 g.

The food emulsions preferably have a Stevens value at 20° C. in the range of from 300, 350 or 400 to 600, most preferably of from 400 to 500, such as 400 to 450. The food emulsions preferably have a Stevens value at 50° C. in the range of from 120 or 130 to 160. It is especially preferred that the food emulsions have a Stevens value at 20° C. in the range of from 300 to 600 and a Stevens value at 50° C. in the range of from 120 to 160.

It is especially preferred, although not essential, that the food emulsions of the invention have a Stevens value at 90° C. in the range of from 25 to 70, most preferably 30 to 60.

The food emulsions should be stable emulsions at the temperature they reach after addition to the hot food product, that is they should not break down or the emulsion should not be broken. If the emulsion breaks at the temperature it reaches on the hot food product then it is no longer attractive to the consumer. The Stevens values at 50° C. herein are values for the food emulsions which are still emulsions at this temperature. It does not refer to, or encompass, emulsion products which have broken down before reaching a temperature of 50° C.

Oil

The oil-in-water food emulsions comprise an amount of from 20 to 65% wt oil based on the weight of the emulsion, preferably 30 to 60% wt oil, most preferably 35 to 55% wt oil.

The oil is preferably selected from oils of vegetable origin, especially triglyceride oils of vegetable origin. The following vegetable derived oils have been found to be especially suitable; rapeseed, sunflower, corn, olive, soy bean, palm, sesame, canola, safflower and linseed oil and mixtures thereof.

The oil may be only non-crystallised oil, or, a blend of crystallised and non-crystallised oil may be used. For the purpose of the present invention, the definition of oil includes purely liquid oil and liquid oils comprising some crystallised fat content.

Water

The oil-in-water food emulsions preferably comprise an amount of from 10 to 65% wt water based on the weight of the emulsion, preferably an amount of from 15 to 40 or 50% wt.

Thermo-Reversible Emulsion Forming Material

The thermo-reversible emulsion forming material may be any suitable material which when included in the food emulsion makes the food emulsion thermo-reversible in its properties, that is, it undergoes a reduction in Stevens value (viscosity) when heated and returns to substantially its original value when cooled to the starting temperature.

The thermo-reversible emulsion may have, for example, the form of a gel or a paste depending upon the amount of the thermo-reversible emulsion forming material included in the emulsion, provided that it meets the claimed Stevens value requirement.

Without wishing to be bound by theory, it is believed that this material stabilises and thickens the aqueous phase of the emulsion and is responsible for the ‘melting’ appearance of the emulsion when it comes into contact with the hot food product.

Especially preferred thermo-reversible emulsion forming materials are gelatin and enzyme treated starches Gelatin has been found to give especially good results as products comprising gelatin show very good melting characteristics when those products are in contact with a hot food product. Furthermore, the products exhibit good stability and thickness upon storage at ambient.

Any suitable gelatin may be used, for example pork or beef derived gelatin. A mesh size of 10 to 50, especially 20-30 is preferred.

The oil-in-water food emulsions preferably comprises up to 5% wt of the thermo-reversible emulsion forming material, preferably an amount of from 0.1 to 3% wt, most preferably of from 0.2 to 1.5% wt. Gelatin used in an amount of from 0.3 to 1.5% wt, preferably 0.5 to 1.0% wt has been found to be especially advantageous.

pH

The food emulsions preferably have a pH at 20° C. in the range of from 3.4 to 4.0. The exact pH will depend upon the flavour desired for the emulsion and whether preservatives are also present in the emulsion. At the more acidic pHs, added preservatives are often not necessary as the low pH inhibits the growth of pathogens and/or spoilage yeasts or moulds.

The oil-in-water food emulsions preferably have an un-dissociated (acetic) acid content in the aqueous phase of the emulsion of up to 5.0% wt based on the weight of the aqueous phase, preferably of from 0.1 to 2.0% wt.

The acid content may be provided by the inclusion of any edible acid. These acids are present in the aqueous phase of the emulsion. Suitable edible acids include acetic acid, citric acid, edible hydrochloric acid, edible phosphoric acid, malic acid, tartaric acid, gluconic acid and lactic acid.

Emulsifier

An emulsifier is typically included in the oil-in-water food emulsions and any suitable edible emulsifier may be included.

It is preferred that the emulsifier is an egg yolk derived emulsifier, most especially one selected from egg yolk, stabilised egg yolk, fortified stabilised egg mix, dried egg yolk, salted egg yolk, enzymatically treated egg yolk and whole eggs.

The oil-in-water emulsions preferably comprise an amount of from about 1 to 8% wt of emulsifier, preferably 2 to 7% wt based on the weight of the oil-in-water emulsion.

Other Optional Ingredients

The oil-in-water food emulsions of the invention may comprise one or more optional ingredients selected from flavourings, preservatives, edible acids, sugar, salt, yoghurt, stabilisers, starches, colourings, and thickeners. Such ingredients may be in a liquid or semi-liquid form. Flavour ingredients may be based on, for example: mustard, salt and pepper, sugar, flavouring herbs, flavouring vegetables (garlic, onions, peppers etc). Thickeners may be based on, for example: starches and gums.

The amount of these optional ingredients will depend upon the type of ingredient included but will typically be in the range of from 0.05 to 2.5 or 5% by weight per type of ingredient (individual flavour etc). However, depending upon the flavour of the dressings, certain ingredients such as sugar or flavours such as mustard or vegetables may be present in greater amounts, e.g. up to 10% wt of the product.

The food emulsion of the invention may be a sauce or dressing for hot food product, especially for hot meat, fish, poultry, fruit or vegetables.

Process to Prepare the Emulsion

A food emulsion according to the present invention may be prepared by any known process for producing emulsions, including heating and homogenising the emulsion ingredients to form an oil in water emulsion followed by cooling the emulsion under shear.

A preferred process for preparing the emulsions is given according to the second aspect of the invention.

It is preferred, especially when gelatin is used as the thermo-reversible emulsion forming material, that the first liquid phase is formed at a temperature in the range of from 70 to 90° C.

The first liquid phase preferably further comprises at least one ingredient selected from flavourings, preservatives, edible acids, sugar, salt, yoghurt, stabilisers, starches, colourants and thickeners. Also it is preferred that no more than 50% wt, preferably no more than 40% wt, of the first liquid phase is mixed with the emulsifier to form an emulsifier-containing first liquid phase. It is also preferred that 30 to 70% wt of the total amount of oil is mixed with the emulsifier-containing first liquid phase.

Any suitable apparatus may be used to carry out the process of the invention.

The invention is further exemplified by the following examples, which are to be understood as to be non-limiting. Further examples within the scope of the invention will be apparent to the person skilled in the art.

### EXAMPLES

### Example 1

The oil-in-water food emulsion in table 1 was prepared by the method given below. All numbers are given as percentages by weight based on the total weight of the composition.

TABLE 1
example 1

| Ingredient | % by weight |
|---|---|
| Water | 13.34 |
| Rapeseed oil | 40.0 |
| Egg-yolk derived emulsifier | 4.0 |
| gelatine pork 250 bloom | 0.83 |
| Mustard DV 10 | 25.0 |
| Sugar | 8.0 |
| vinegar (10%) | 3.6 |
| Flavourings, salt, colouring, | 4.98 |
| Skim milk powder (1%) | 0.25 |
| Total | 100.00 |

The emulsion was prepared by firstly forming a mixture of the gelatin and the water at about 85° C. After about 10 minutes the mustard, sugar, vinegar, milk powder, other flavorings, salt, and colouring were added to the mixture and it was mixed well to form a first liquid phase. Next, 20% wt of the first liquid phase was mixed with the emulsifier and 50% wt of the oil was added thereto with stirring. The remainder of the oil and the first liquid phase were added thereto and mixing continued until an acceptable product was obtained.

The oil-in-water food emulsion had a Stevens value at 20° C. in the range of from 354 to 436 over a series of measurements. The measurements were carried out at 20° C. using a Stevens LFRA Texture Analyser using the following parameters; 25 mm depth, speed of penetration 2.0 mm per second, using a normal programme, grid mesh of 3.8 cm by 3.8 cm with apertures of 8 mm by 8 mm. The values are quoted herein as the Stevens value (in g). The accuracy of this measurement in all cases is up to about ±10 g.

The food emulsion showed good stability and thickness at 20° C. When contacted with a hot food product it exhibited good melting characteristics which was pleasing to consumers. By this is meant that it exhibited a viscosity change upon contact with the food product which was observed by consumers to be a type of melting behaviour. The Stevens value at 50° C. was in the range of from 100 to 200 over a series of measurements.

### Example 2 (Comparative)

The gelatin in example 1 was replaced in a series of food emulsions by xanthan gum, guar gum, carageenan gum, pectin, wheat starch, tapioca and waxy maize. None of these alternative materials were found to produce the desired melting characteristics of the food emulsion. The food emulsions were either so stable that there was hardly any viscosity change when contacted with the hot food product, or, they were not stable at storage at ambient temperature.

1. An oil-in-water food emulsion having a pH at 20° C. in the range of from 3 to 4 and comprising:
(i) from 20 to 65% wt oil;
(ii) from 10 to 65% wt water;
(iii) up to 5% wt of thermo-reversible emulsion forming material selected from gelatin or enzyme-treated starches; and
(iv) from 1% to 8% wt of emulsifier,
wherein the food emulsion has a Stevens value at 20° C. in the range of from 250 to 600 and a Stevens value at 50° C. in the range of from 100 to 200.

2. An oil-in-water food emulsion according to claim 1 wherein the emulsion has a Stevens value at 20° C. in the range of from 300 to 600.

3. An oil-in-water food emulsion according to claim 1 wherein the emulsion has a Stevens value at 50° C. in the range of from 120 to 160.

4. An oil-in-water food emulsion according to claim 1, wherein the emulsion has a Stevens value at 20° C. in the range of from 300 to 600 and a Stevens value at 50° C. in the range of from 120 to 160.

5. An oil-in-water food emulsion according to claim 1, wherein the emulsion comprises an amount of from 30 to 60% wt oil.

6. An oil-in-water food emulsion according claim 1, wherein the oil is selected from oils of vegetable origin.

7. An oil-in-water food emulsion according to claim 1, wherein the emulsion comprises gelatin.

8. An oil-in-water food emulsion according to claim 1, wherein the emulsion comprises an amount of from 0.2 to 1.5% wt of the gelatin or enzyme-treated starch.

9. An oil-in-water food emulsion according to claim 1, wherein the emulsion has an undissociated acid content in the aqueous phase of the emulsion of up to 5.0% wt based on the weight of the aqueous phase.

10. An oil-in-water food emulsion according to claim 9, wherein the emulsion has an undissociated acid content in the aqueous phase of from 0.1 to 2.0% wt.

11. An oil-in-water food emulsion according to claim 1, wherein the emulsion comprises 2 to 7% wt of an emulsifier, based on the weight of the emulsion.

12. An oil-in-water food emulsion according to claim 1, wherein the emulsion is a sauce or dressing for hot meat, fish, poultry, fruit or vegetables.

13. A process for the preparation of an oil-in-water food emulsion as claimed in claim 1, the process comprising the steps of:
a) forming a first liquid phase comprising the thermo-reversible emulsion forming material, selected from gelatin or enzyme-treated starch, and water, wherein the first liquid phase is formed at a temperature in the range of from 60 to 95° C.;
b) mixing at least a part of the first liquid phase with an emulsifier to form an emulsifier-containing first liquid phase;
c) mixing at least a part of the oil with the emulsifier-containing first liquid phase;
d) mixing the, or any, remaining first liquid phase and remaining oil with the emulsifier-containing first liquid phase to form the oil-in-water food emulsion.

14. A process according to claim 13, wherein the first liquid phase further comprises at least one ingredient selected from flavourings, preservatives, edible acids, sugar, salt, yoghurt, stabilisers, starches, colourants and thickeners.

15. A process according to claim 13, wherein no more than 50% wt of the first liquid phase is mixed with the emulsifier to form an emulsifier-containing first liquid phase.

16. A process according to claim 13, wherein 30 to 70 % wt of the total amount of oil is mixed with the emulsifier-containing first liquid phase.
